(19) United States
(12) Patent Application Publication
(10) Pub. No.: US 2002/0152393 A1
(43) Pub. Date: Oct. 17, 2002

(54) Secure extensible computing environment

(76) Inventors: Johannes Thoma, Vienna (AT); Shawn Murphy, Marblehead, MA (US); Christian Schallhart, Vienna (AT)

Correspondence Address: DENIS G. MALONEY, Fish & Richardson P.C., 225 Franklin Street, Boston, MA, 02110-2804, US

(21) Appl. No.: 10/041,772

(22) Filed: Jan. 8, 2002

Related U.S. Application Data
(60) Provisional application No. 60/260,543, filed on Jan. 9, 2001.
(60) Provisional application No. 60/262,157, filed on Jan. 17, 2001.

(51) Int. Cl. H04L 9/32

(52) U.S. Cl. 713/189

(57) ABSTRACT

A method of downloading encrypted e-content to a terminal device includes receiving a request for encrypted content from a terminal device. A content server generates a private symmetric key and encrypts the e-content with the symmetric key. A key server looks up the terminal device public key in a key repository and sends the symmetric key encrypted with the public key of the terminal device to the content server. The key server generates a unique license ID and produces an entry in a license repository. The content server sends a response to the terminal device including the content encrypted with the symmetric key. Transfer tickets and challenges received from the content server are used to activate the e-content license. Additionally, trading of e-content licenses between users, activation of an e-content license transferred from a giver's terminal device to a borrower's terminal device are also supported. For viewing secure content on a personal computer a secure extensible computing environment is implemented on a personal computer peripheral card while processing of the content is performed in encrypted form in the computer. The content is delivered in encrypted form to the secure extensible computing environment on the personal computer peripheral card and decrypted therein.

This application claims the benefit of U.S. Provisional Patent Application serial no. 60/260,543 filed Jan. 11, 2001 entitled “SOFTWARE ARCHITECTURE FOR SECURE CONTENT DISTRIBUTION, STORAGE AND VIEWING/PLAYING ON A DEVICE” and U.S. Provisional Patent Application serial no. 60/262,157 filed Jan. 17, 2001 entitled “SOFTWARE ARCHITECTURE FOR SECURE CONTENT DISTRIBUTION, STORAGE AND VIEWING/PLAYING ON A DEVICE” both of which are incorporated herein by reference in their entirety.

### BACKGROUND

This invention relates to digital rights management techniques.

Copy protection systems are available for protecting content from exploitation by intruders. Today content, e.g., music, movies, publications, and so forth, are available and are delivered in digital format. Delivery can occur in many forms such as through hard media, e.g., optical disk, the Internet, cable television, and so forth. . Piracy of digital content, especially online digital content, is a problem. For example, in some systems a special audio driver can be installed into an operating system that writes data it plays to mass storage while playing back the content. The result is a sound file in e.g., “.Wav” format which can be copied and played back without restrictions.

Generally, a publisher or reseller gives or sells the content to a client, but places restrictions on rights to use the content. For instance, a publisher generally will retain copyright to a work so that the client cannot reproduce or publish the work without permission. “Digital rights management” is a technology that has developed to protect digital content from unlawful exploitation while still fostering the demands of commerce

### SUMMARY

According to an aspect of the present invention, a method of downloading encrypted e-content to a terminal device includes receiving a request for encrypted content from a terminal device and generating a symmetric key and encrypting the e-content with the symmetric key. The method also includes sending a request to a key server to look up the terminal device public key in a key repository and receiving from the key server the symmetric key encrypted with the public key of the terminal device. The method includes generating a unique license ID and producing a new entry in a license repository and sending a response to the terminal device including the content encrypted with the symmetric key.

According to an additional aspect of the present invention, a method of activating e-content license with terminal device includes sending to a content server a transfer ticket and challenge and receiving a solved challenge and transfer ticket back from the content server. The method checks the challenge and transfer ticket to activate the e-content license.

According to an additional aspect of the present invention, a method of trading e-content licenses between users, includes unregistering e-content license at a giver's device and issuing a relinquishing ticket by the giver's device. The method also includes registering the license with a borrower's device using the issued relinquishing ticket.

According to an additional aspect of the present invention, a method executed on a content server for allowing activation of an e-content license transferred from a giver's terminal device to a borrower's terminal device includes receiving a relinquishing ticket and challenge from the giver's terminal device and checking a value of the relinquishing ticket. The method includes incrementing the expected value of relinquishing ticket for the giver's device and assigning the borrower device as new owner. The method sends a solved challenge and a transfer ticket back to the borrower's terminal device to allow the borrower terminal device to check the challenge and the transfer ticket to activate the e-content license.

According to an still further aspect of the present invention, a method of viewing secure content on a personal computer that executes a non secure operation system includes providing a secure extensible computing environment on a personal computer peripheral card and processing the content in an encrypted form in the computer and delivering the content in encrypted form to the secure extensible computing environment on the personal computer peripheral card and decrypting the content in encrypted form on the personal computer peripheral card.

One or more aspects of the invention may provide one or more of the following advantages.

The invention provides protection of a master key. On a terminal device eventually a bit string is produced that is not encrypted in order for users to consume content. This invention provides protection against intrusion mechanisms at the software level and at the hardware level. The invention provides a computing environment that is protected by hardware techniques for storing the master key and processing, i.e., decrypting and driving peripherals, such as a speaker or display. The approach also provides operating system level protection. The system allows peripheral cards for PC based to implement content protection processes.

The invention provides a digital rights management system (DRM) that provides a secure distribution system that is easy and convenient to use. The invention enables content manufactures and distributors to sell content electronically, and provides a secure distribution system that allows copyright holders to control electronic content after distribution. The invention also allows free selection of the terminal device on which content is consumed. That is, the invention enables a wide variety of devices to distribute digital content to. The invention also provides a system that allows for transferring content from one terminal device to another, while still protecting the rights of the copyright owner.

An aspect of the invention features controllable server-to-server, server-to-client and client-to-client transactions, and is thus applicable for business-to-business (B2B), business-to-consumer (B2C) and peer-to-peer (P2P) segments.

### BRIEF DESCRIPTION OF THE DRAWINGS

The details of one or more embodiments of the invention are set forth in the accompanying drawings and the description below. Other features, objects, and advantages of the invention will be apparent from the description and drawings, and from the claims.

FIG. 1 is a block diagram of a system providing a secure extensible computing environment for distributing and consuming e-content.

FIG. 2 is a block diagram of a terminal device.

FIG. 3 is a diagram of software processes.

FIG. 4 is a flow chart of aspects of an operating system for the terminal device.

FIGS. 5A-5B are block diagrams of data structures.

FIG. 6 is a diagram of a ticket.

FIG. 7 is a flow chart of a process for secure content delivery.

FIG. 8 is a flow chart of a process for registering content licenses.

FIGS. 9A-9C are flow charts showing details of a process for downloading and activating e-content licenses.

FIG. 10 is a flow chart of a peer-to-peer operation allowing unregistering licenses.

FIG. 11 is a flow chart of a process to unregister a license and deactivate e-content on a terminal device.

FIGS. 12A-12B are flow charts depicting a process for registering a license for another device in a peer-to-peer transaction.

FIG. 13 is a flow chart of a process to reregister a license on an originally licensed device.

### DETAILED DESCRIPTION

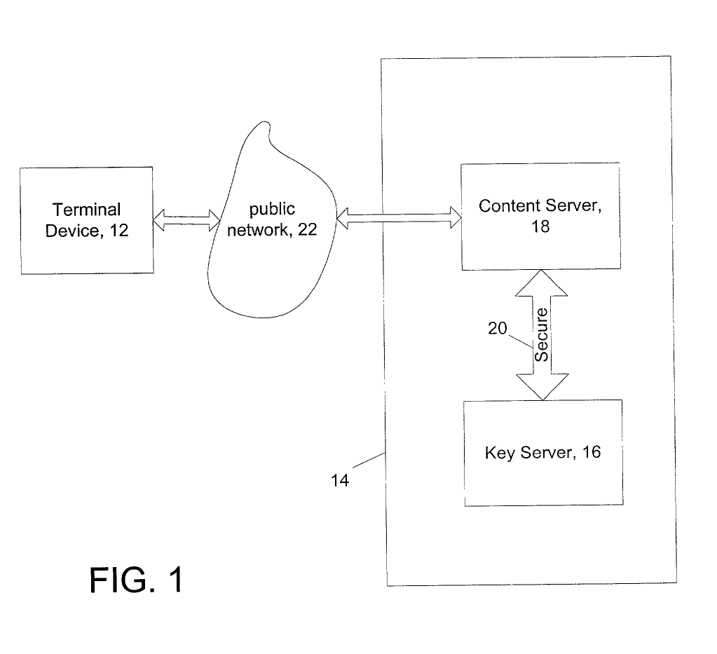

Referring to FIG. 1, a system 10 for distributing and consuming e-content while preventing intruders from breaking security of the e-content at a terminal device 12 is shown. The system 10 includes a controlled environment 14 comprised of a key server 16, a content server 18 and a secure link 20 between the key server 16, a content server 18. The system 10 also includes the terminal device 12. The terminal device 12 is used to consume e-content and at times during transfers of e-content is coupled to the content server 18 via a public, non-secure link, e.g., the Internet 22. The key server 16 is a centralized server that knows master key pairs of all terminal devices 12. Because all secure transactions in the system 10 require knowledge of the master key pair, other devices need to communicate with the key server 16 in order to exchange messages. The only exception are terminal devices 12 which have a private key of the master key in their secure, e.g. protected storage area. The key server 16 may be replicated over secure channels to other locations in order to maximize availability (backup servers) and responsiveness (load balancing). Also, the chance of a successful distributed denial of service attack against a key server 16 is decreased when replicating key servers. The key server 16 is located in a secure area of inter network in order to prevent intruders from attacking it directly.

The content server 18 hosts content files and delivering the content files to terminal devices. The content server 18 encrypts content on the fly and request individual license keys from the key server 16. The content server 18 can be hosted by any trusted party with access to the Internet or other public network. Typically, a copyright holder would host the content server 18 for its content. The content server 18 is located in the secure area of inter network in order to prevent intruders from attacking it directly, since it has content stored that is not encrypted. However, if one content server is successfully intruded, content on other content servers is not affected. The content server 18 communicates with key server 16 over a secure Internet connection since it transmits individual content key. A preferred embodiment of the transmission is over a secure socket layer (SSL) connection with mutually authentic keys, that is, use of public key infrastructure (PKI). The content server 18 also typically holds the license repository that has information about registered licenses. The license repository can also be hosted on a separate server, which is connected to other servers over secure Internet connections.

Data structures stored on the various computer devices, software, and communication protocols between the key server 16, the content server 18 and the terminal device will be described below. The content server 18 and key server 16 are hosted in the controllable environment 14, so no further mechanism is needed in order to make sure that they follow the protocol. For the terminal device 12, the mechanisms for secure computing environment make sure that they follow protocols defined herein. Additionally, it is not a requirement that the key server 16 be hosted separately from the content server 18. Both processes could be hosted on the same machine provided that mechanism were in place to safeguard access to the key server process from hacking.

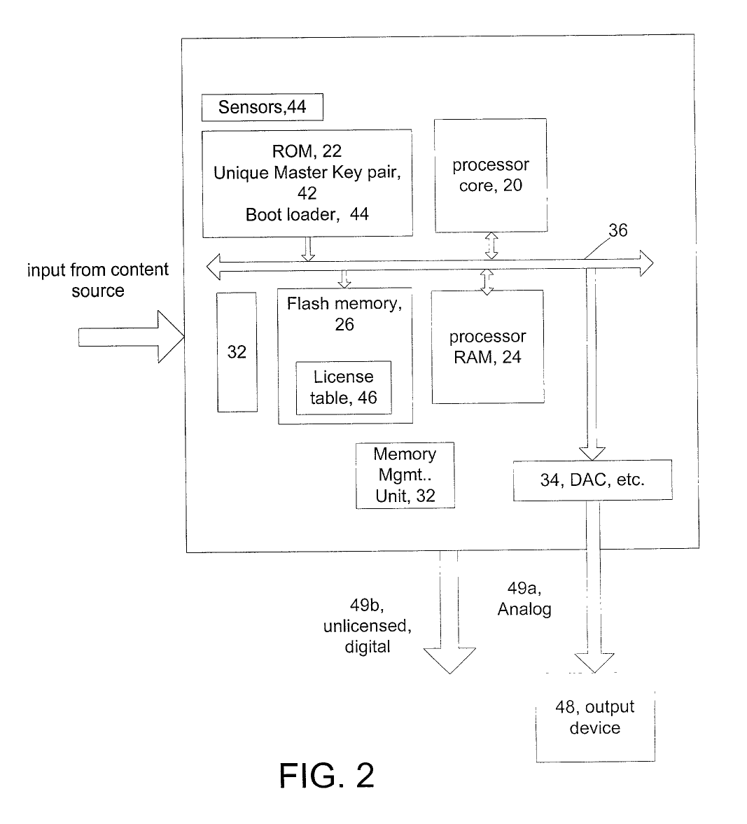

Referring to FIG. 2, the terminal device 12 has an architecture that prevents intruders from breaking security at the terminal device 12. Since the terminal device 12 cannot be physically controlled by copyright holders or their representatives, the system architecture is provide to prevent intruders from tampering with the terminal device 12. The terminal device 12 provides a secure extensible computing environment that includes a processor core 20, a memory management unit 22, local dynamic memory storage (RAM) 24, local persistent storage 26, e.g., flash memory, local read only memory (ROM) 28, and application specific peripheral drivers 30. The terminal device also includes an input interface 32 and an output interface 34. The various components are coupled together via at least a system bus 36. The ROM 28 is one-time writable. At the factory, a boot-loader 40 and a private key 42 of the master key pair are burnt into the ROM 28. Both can never be changed thereafter. The secure extensible computing environment is also protected against physical access by sensors 44. Sensors trigger a mechanism that erases the private key or otherwise makes the private key inaccessible. One embodiment implements the secure extensible computing environment on a single chip.

The terminal device 12 is a device that users consume content with. As an example, consuming content can mean listening to an audio track, watching a video clip or a movie, reading a book or other publication but is not limited to these uses. The terminal device 12 can be thought of as a blackbox with an encrypted data stream as input and signals for peripherals (TV, speaker, . . . ) as output, and a mechanism that controls whether the encrypted data stream is accepted for output or not. The terminal device 12 can be an embedded special purpose device, such as a cellular phone, UMTS terminal, car entertainment system (again, not limited to that type of device) or it can be a personal computer or a peripheral controller of an industry standard PC or Mac computer system. For example, the terminal device 12 can be a modified video card or sound card.

The terminal device 12 is part of a secure extensible computing environment 50, as described below. The secure extensible computing environment 50 comprises a protected memory area that cannot be directly read or modified by the user, except in system-defined ways. Each terminal device 12 is equipped with the unique private key stored in protected memory. The private key is used to decrypt an encrypted license key, which in turn is used to decrypt content for further display or playback. The private key is actually the private key of an asymmetric cipher's key pair. This key is burnt into the terminal device 12, e.g., ROM 28 and cannot be changed. Every secure transaction in the system 10 requires knowledge of the private key. The security property of the system 10 is based on the assumption that the terminal device 12 user does not know the private key. This is the only assumption in system 10, and system 10 undertakes every effort to maintain the secrecy of the private key.

The terminal device can also include a power management unit (not shown) with an embedded battery that provides protection to protected memory devices independent of an onboard power supply. For example, the terminal device electronics can include integrated sensing and protection that can cause the power management unit to produce a local high voltage to apply to protected memory to cause irreversible private key destruction in the event that the sensors detect tampering with the protected memory devices, e.g., the ROM 28 which has the boot loader and the private key.

A symmetric key is used to encrypt content, whereas, an “asymmetric” cipher having a private and a public key is used to encrypt the symmetric key. That is, the content server will encrypt the symmetric key with the public key of a private-public key pair and the private key will be used by the terminal device to obtain the symmetric key.

The terminal device 12 also stores in a license table 46 information about the licenses that are registered for the terminal device 12. Each license is registered for (at most) one terminal device 12 at a particular point in time. A license can be transferred to another device. A valid registered license is required on the terminal device 12 to start decrypting and playing back content. In other words, the terminal device 12 is built such that it refuses to decrypt and play back content, if there is not a valid license on the device 12.

The terminal device 12 drives an output device 48, e.g., speakers, display, monitor, etc. directly, as an analog signal. For example, if the terminal device 12 is used for audio playback (such as car entertainment system or PC sound card), it outputs licensed content as an analog signal via lines 49a directly to the speakers or the stereo. The terminal device 12 may optionally have digital outputs 49b. If the terminal device had digital outputs, the optional digital outputs would be used to output non-licensed digital content or encrypted, licensed digital content to a compatible device. Only licensed digital content that was encrypted, would be output over digital outputs for copy protection reasons.

The terminal device 12 could be a personal computer, or other type of computer device that meets requirements of system security as described below. Alternatively, to provide this security framework on a personal computer the security mechanisms can be implemented on a peripheral card e.g., sound card, video card and so forth. The personal computer would deliver an encrypted data stream to the peripheral card. A server can also act as terminal device 12 allowing secure content exchange between servers.

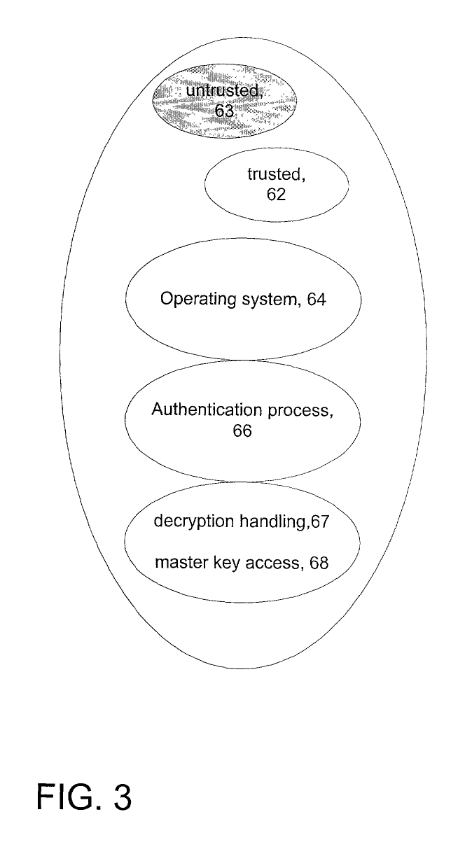

Referring to FIG. 3, software in the terminal device 12 is kept secure, such that it is not possible to modify software so that the terminal device 12 can be intruded and the content obtained in nonencrypted form. The software architecture is also kept extensible, such that new or updated programs can be loaded into the computing environment. The software architecture separates software into trusted 62 and untrusted 63 software and only allows trusted software 62 to decrypt content and using secured interfaces for having content decrypted. To prove authenticity of trusted software to defeat Trojan horse and similar attacks, digital signatures encrypted with terminal device 12 private key are used.

As used herein, symmetric encryption refers to an encryption process that uses the same key for encrypting and decrypting data. Asymmetric encryption uses two different keys for encryption and decryption (where there is no feasible way to compute one key from the other) and as compared to symmetric encryption, is relatively slow. Typically one of the keys is kept private, and is therefore referred to as private key, and the other is published which is referred to as public key. Typically, asymmetric encryption is used in conjunction with symmetric encryption because of performance reasons. If both encryption methods (ciphers) are secure enough, this combination does not introduce additional security leaks. For the aforementioned features, for implementing privacy, generate a random symmetric key, encrypt content with symmetric key, encrypt symmetric key with public key and send both encrypted content and encrypted key to receiver. For implementing a digital signature, build secure hash over data, encrypt secure hash with private key and send encrypted secure hash together with data (not encrypted) to receiver. A secure hash is a function with one parameter and the following properties: Injective that is, more than one parameter value can yield the same result, and that there is no feasible way to compute another parameter that has the same result from one parameter.

A cipher is an algorithm that does encryption and decryption. The system 10 is not bound to specific ciphers, however, modem ciphers where soundness is well-proven are preferred. For example, system 10 could use advanced encryption standard (AES) for symmetric encryption, Rivest-Shamir-Adleman (RSA) for asymmetric encryption and MD5 for generating secure hashes. The system 10 uses encryption technology to encrypt content, encrypt communication between devices and for proving authenticity of software.

The following mechanisms at the software side are used to implement a secure extensible software environment 60.

The system 10 provides the firmware boot loader in hardware so that it cannot be replaced. The tamper resistant computing environment for storing and processing critical data ensures that firmware cannot be changed. The main purpose of the boot loader is to load an operating system 64 into (main) memory and pass control to operating system 64. The boot loader 42also restricts bootable operating systems (OS) to digitally signed system software.

Asymmetric encryption can be used to provide the digital signature. The digital signature provides proof of authenticity. The digital signature encrypts data such that receivers can be sure that a holder of a private key actually produced or authorized data. The holder of a private key encrypts the data and the receiver decrypts the data with the public key. Because only private key holders can generate the encrypted data, receivers can be sure that the private key holder produced or authorized the data. The secure extensible software environment 60 employs this mechanism for authenticating of some of the programs running on terminal device 12. The digital signature proves that application software has been checked for routines that can provide security leaks or doors (“backdoors”) into data processed by the application software. The software architecture also restricts loadable parts of the operating system 64 (OS) to digitally signed software. The digital signature proves that software has been checked for backdoors. The software architecture also restricts programs that may operate on licensed material to digitally signed software. The digital signature proves that software has been checked for backdoors.

The software architecture also implements decryption handling, access of private key and other procedures that require access of protected computing environment as part of operating system 64, or as loadable part in operating system 64.

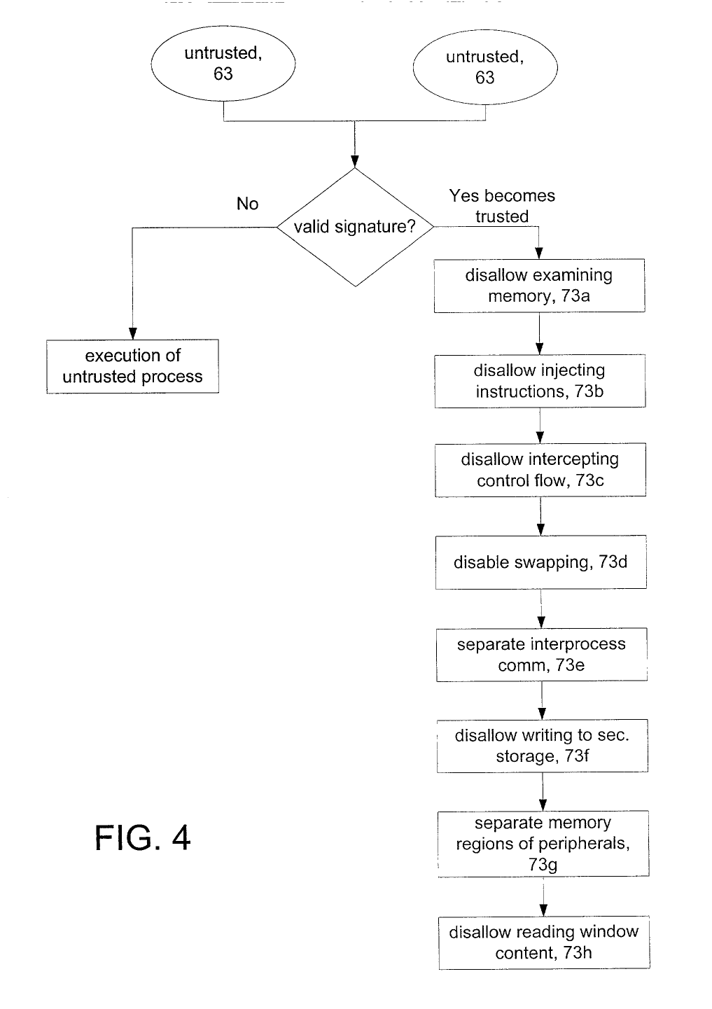

Referring to FIG. 4, the operating system 64 exhibits the following characteristics. The operating system 64 handles trusted 71a and untrusted 71b processes according to a status flag 72. The operating system 64 has a modified program loader where all loaded programs run as untrusted processes and that such processes lose trusted status (they become untrusted) when a program loads additional parts of program (library code) into memory. The operating system 64 can have an interface 75 through which programs can request a status change from running in an untrusted process to a trusted process.

The operating system 64 disallows 73a examining memory of trusted processes and disallows modifying memory of trusted processes. The operating system 64 will also disallow 73b injecting instructions into trusted processes, disallow 73c intercepting control flow of trusted processes, and disable 73d swapping and/or paging to secondary storage for trusted processes.

The operating system 64 will separate inter-process communication channels of trusted processes from those of untrusted processes preventing 73e untrusted processes from reading data from trusted processes. The operating system 64 will disallow 73f writing to secondary storage and writing to communication channels (like networks) for trusted processes and separates 73g memory regions of peripherals that are controlled by trusted processes from untrusted processes so that untrusted processes cannot read data from memory regions controlled by trusted processes. In addition, the operating system 64 will prevent 73h an untrusted process from reading window content controlled by a trusted process in video RAM or buffered window content. An interface 76 for adding a private key is accessible only by trusted applications. However, the operating system 64 can support 77 an interface that allows trusted applications to read a content stream that is decrypted by the operating system 64 on the fly. There are no preferences regarding operating system 64 to use, however, an operating system 64 designed for embedded systems is preferable (such as VxWorks®) or Embedded Linux®) over standard desktop operating systems 64.

An alternative approach to providing the terminal device 12 as PC-based system would use an add on. Rather than implementing the aforementioned directly on PC computing environments the system 10 instead implements the secure extensible computing environment on a PC peripheral card. Thus, in this alternative the PC system uses a special sound card, a special video card, and so forth to receive an encrypted stream from the PC's processor. Logic on the special sound card, etc. decrypts the stream and decodes the decrypted stream (e.g., from MP3 audio format), and outputs the result as analog signal directly to speakers attached to the PC. Thus in a sense, the terminal device for an alternative PC implementation is the special PC peripheral card or device. The host operating system 64 (typically Microsoft Windows® or Mac OS® from Apple Inc.) and hardware only operates on the content in its encrypted form since the operating system 64 and the hardware do not have the key to decrypt it. Intruders attempting a man-in-the-middle attack are defeated due to the protocol design discussed below.

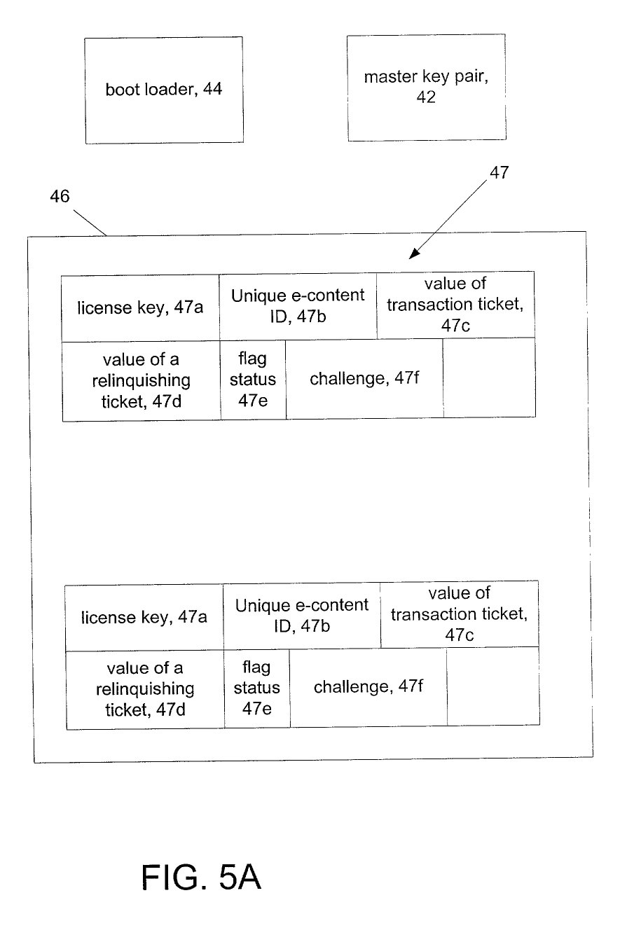

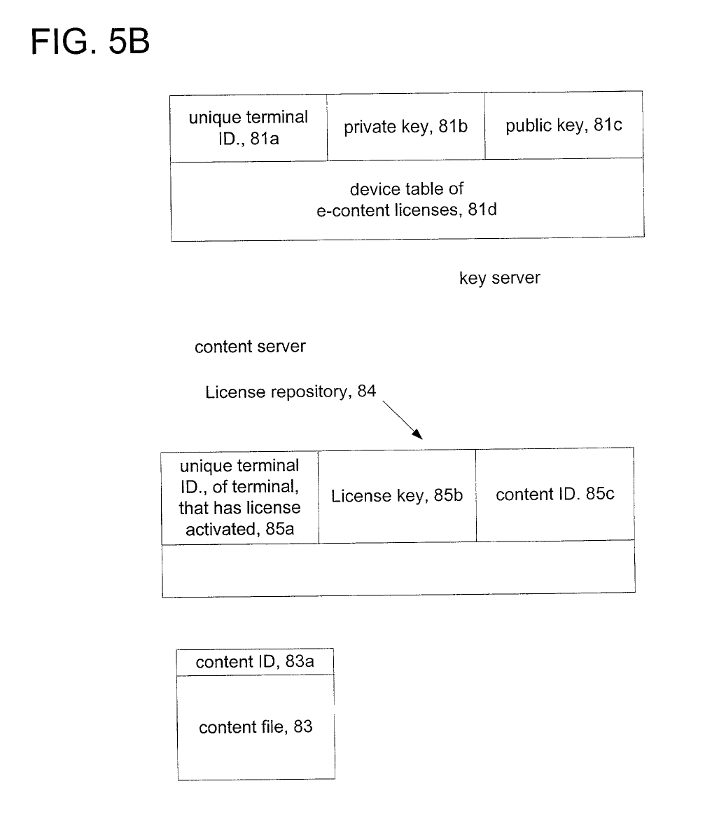

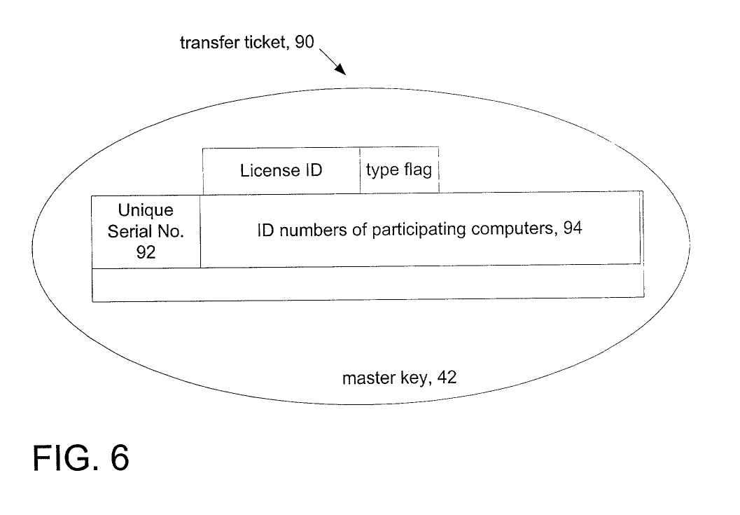

Referring to FIG. 5A, data structures on terminal device 12 are described in more detail. These data structures are protected by hardware and thus cannot be accessed (read or modified) by opening the device. These data can only be accessed in a controllable manner because of system design of secure extensible computing environment. The terminal device includes the Burnt-In Boot loader 40. The terminal device 12 processor 20 executes the boot loader 40 after power on or reset. The terminal device has the unique private key 42, which is not known to an intruder and cannot be modified. The unique public key also cannot be modified. The device 12 stores the table 46 of e-content licenses currently or formerly activated on that device. Each entry 47 in the table of e-content licenses includes a license key 47afor a symmetric cipher for decrypting the e-content and a worldwide unique e-content id 47b for associating a file with the e-content license. The table entries also include a current value 47c of a transfer ticket 90a (see FIG. 6), which is used in activating a license and a current value 47d of a relinquishing ticket 90b (see FIG. 6), which is used in relinquishing a license. The table entries also include an activated status flag 47e. Only licenses with activated status flag 47e in a predetermined state e.g., “set” will be used for decrypting e-content. The table includes a challenge 47f that is given out to an intermediary server.

A challenge 47f is a random number encrypted with the device's public key 47a. The knowledge of the private key is required to solve the challenge. The system 10 uses challenges to prove to the terminal device 12 that a request was accepted by the content server 18 and key server 16.

The license key for a symmetric cipher is not known to the intruder. However, the intruder can see the license key as it is encrypted with the public key. However, the intruder would need the private key to decrypt the encrypted license key. The values of a ticket 90 are known to the user, however, the values of the ticket 90 cannot be modified, since knowledge of the private key is required to generate a valid ticket. The random challenge 47f is unknown to the user and intruders would need the private key to solve the challenge. The encrypted content is not stored in protected memory. The encrypted content can be stored in unprotected memory or streamed into the terminal device 12 during content playback.

Referring to FIG. 5B, the servers 16, 18 hold information about terminal device 12, licenses and which license is registered currently for which terminal device 12. The key server 16 includes a data structure 80 that holds for every terminal device 12 a unique terminal device number 81a, a private key 81b and public key 81c of that terminal device 12. The key server 16 also has a mirror copy 81d of the device's table of e-content licenses that are currently or have been formerly activated on that device. This table 81d holds the expected value 82a of the transfer ticket 90a, the expected value 82b of the relinquishing ticket 90b, and the status of the active flag 82c. This table 81d is indexed by the unique device id and the license id.

The content server 18 stores content as content files 83, typically in a non-encrypted format. Each content file receives a worldwide unique number 83a. The unique number 83a is comprised of the particular content server 18 number and an individual number that is assigned by the content server 18.

A license repository 84 stores information for each copy of e-content downloaded including the terminal device id of the last device that has it activated 85a, the license key 85b, and the content id 85c of the content the license is issued for. Optionally, the license repository 84 can also include a free form data structure 86 that refines permissions for this particular license. The license repository 84 is typically hosted with the content server 18, however, it can be hosted on some other server, as long as this server is connected to the content server 18 with a secure connection.

Referring to FIG. 6, a ticket 90 (e.g., a transfer ticket or a relinquishing ticket) is shown. The ticket type is distinguished by a type flag or which could be a bit or an N-bit random number. The ticket 90 is used to ensure that an action is executed only once. In the system 10 described herein, tickets 90 are used to ensure that a license is registered with a terminal device 12 secure environment only once. A ticket 90 is an encrypted indivisible data structure that is exchanged between computers as part of the system's communication protocol. A ticket 90 has a unique serial number 92 and identification numbers 94 of participating computers. The value of the unique serial number is replicated in an internal state of both participating computers. Ticket 90 is encrypted with the private key 42. Thus, assuming that the private key 42 is unknown, which is the basic assumption in the system 10, the ticket 90 cannot be faked by intruders. Intruders can decrypt the ticket 90 with the public key, but the information in the ticket 90 is not relevant for intruding the system 10.

If there were no ticket 90 in the system 10, the process of registering licenses could be executed more than once by an intruder. Because licenses can also be unregistered and registered on other devices, intruders could then obtain one license and register it on many devices simultaneously.

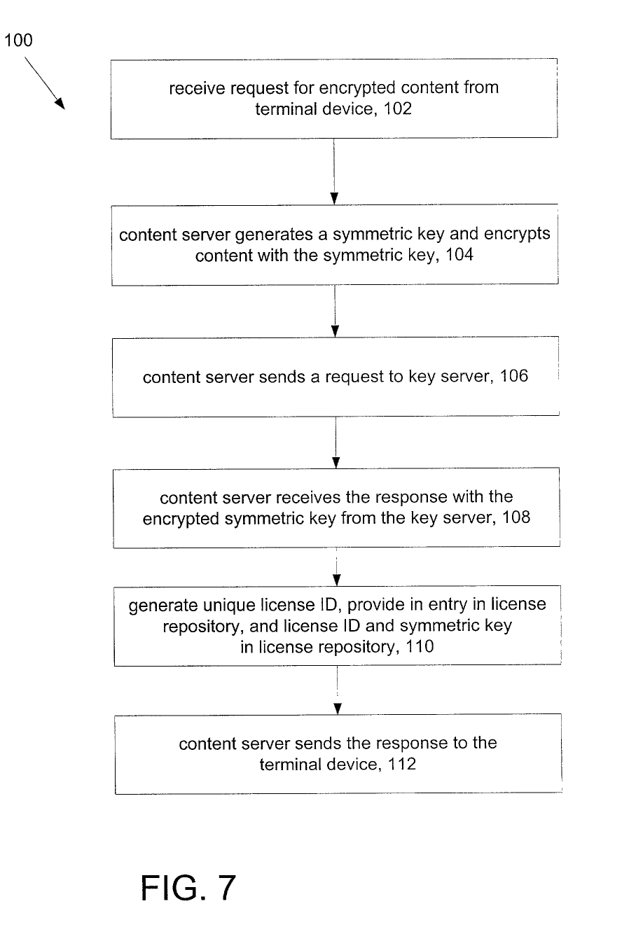

Referring to FIG. 7, a process 100 for secure content delivery includes downloading of encrypted content and registering of a content license. To download encrypted content the terminal device 12 sends a request to the content server 18. The request is received 102 by the content server 18 and includes a unique request ID, a unique ID for content requested and a unique ID for the terminal device 12. The content server 18 generates 104 a symmetric key and encrypts the content with the symmetric key. The content server 18 sends 106 a request to key server 16 over a secure connection. The request includes a unique request ID2, a unique ID of device, and the symmetric key. The key server 16 looks up the public key of device by unique ID of device. If the public key is found, the key server 16 encrypts the symmetric key with the public key and sends a response to content server 18. The received 108 response includes the unique request ID2, the unique ID of device and the symmetric key encrypted with public key. Upon receipt of the response the content server 18 generates 110 a unique license ID, creates a new entry in the license repository and stores license ID and symmetric key in license repository. No owner or assignment to a terminal device 12 occurs at this point. Assignment happens after a license is registered.

The content server 18 sends a response 112 to the terminal device 12. The response 112 from the content server 18 to the terminal device 12 includes the content encrypted with the license key, the license key encrypted with the public key, and the unique request ID. The extra bi-directional transaction with the key server 16 ensures that the correct public key is used for encrypting the license key.

Optionally (not shown), a free form data structure may be generated by content server 18, sent to key server 16 to be signed with the terminal device 12's private key (to be read with the public key) and sent back to terminal device 12. Because the free form data structure is encrypted with the terminal device's 12 private key, the data structure can be neither modified nor faked by the user. The data structure's purpose is to control further properties of content usage (such as expiration date, maximal view count and so on). Note that connections between the terminal device 12 and content server 18 may be over an insecure line, however, the connection between the content server 18 and the key server 16 is over a secure line, such as the secure socket layer (SSL).

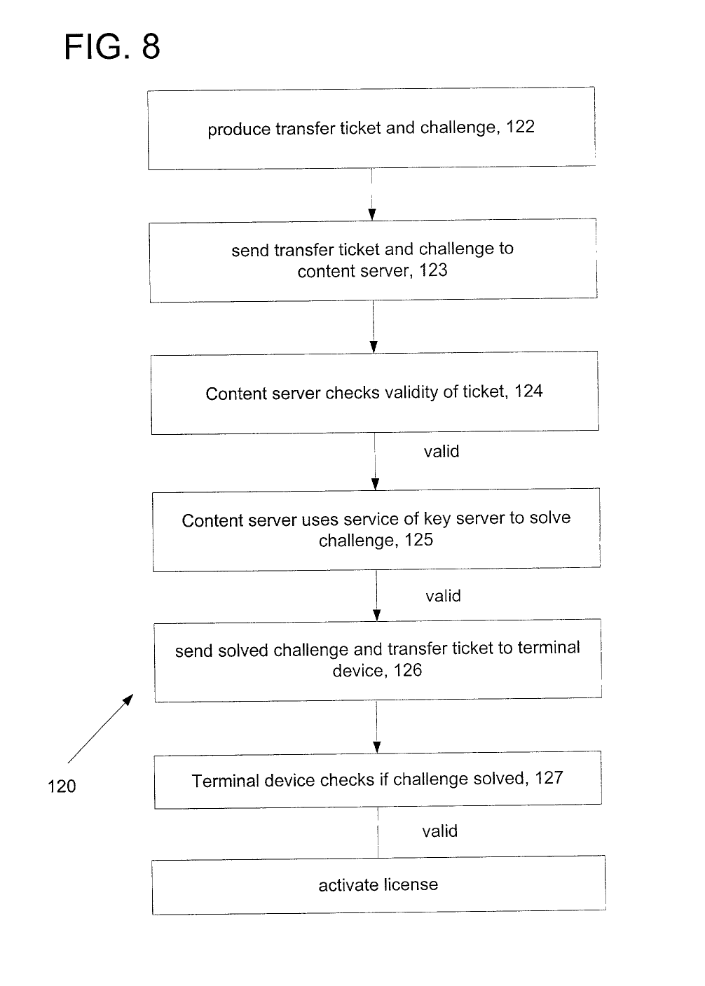

Referring to FIG. 8, a high-level view of a process 120 for registering content licenses is shown. Content cannot be consumed at the terminal device 12 before a valid license is registered for the terminal device 12. Licenses are stored in the protected memory area of the terminal device 12. The transfer ticket 90a is used to ensure that registering of e-content licenses happens only once. The random challenge solved by the intermediary server ensures that the dedicated device actually communicates with the intermediary server. Registering licenses includes producing 122 a transfer ticket 90a and a challenge 91 by the terminal device 12. The terminal device 12 sends 123 the transfer ticket 90a and the challenge 91 to content server 18 over an insecure line. The content server 18 checks 124 the ticket 90 for validity by looking up unique counters in the license repository. If the ticket 90 is valid, the content server 18 uses 125 the service of the key server 16 to solve the challenge. The content server 18 sends 126 the solved challenge and transfer ticket 90a back to terminal device 12. The terminal device 12 checks 127 challenge and transfer ticket 90a and finally activates 128 an e-content license. The e-content can be read after completion of the above process 120.

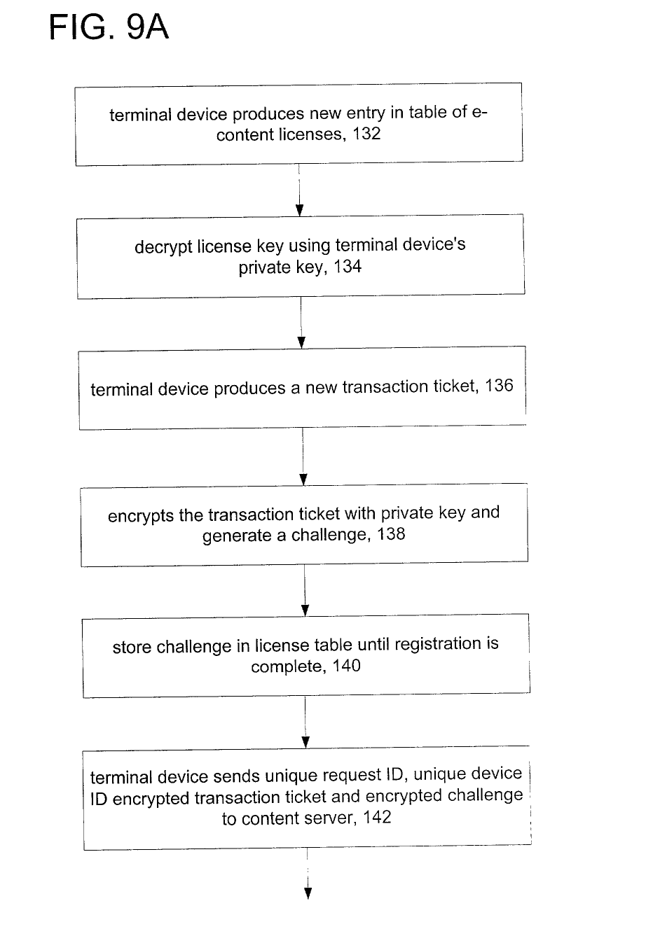

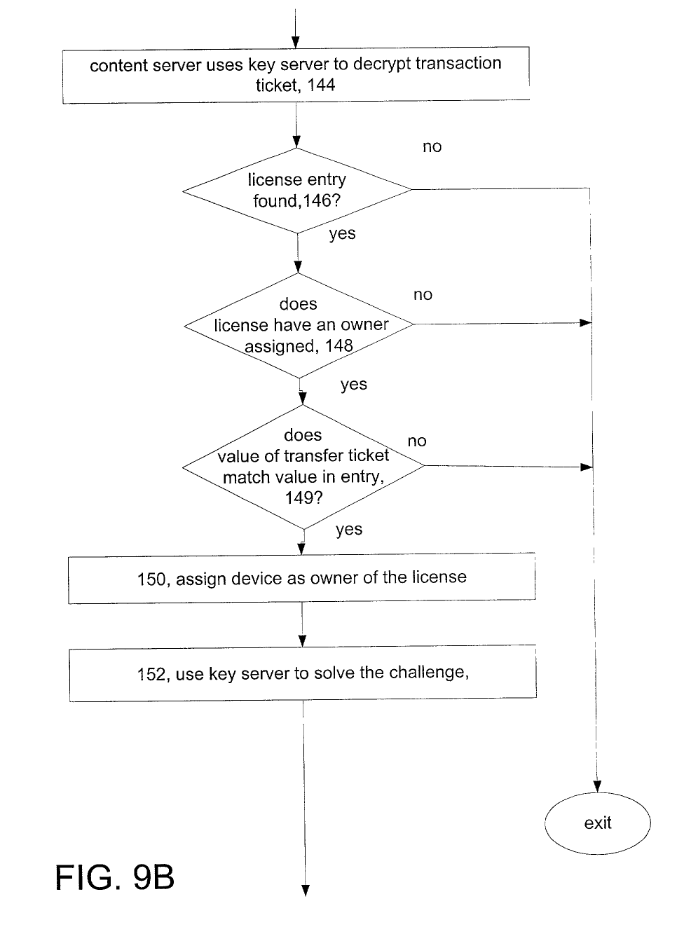

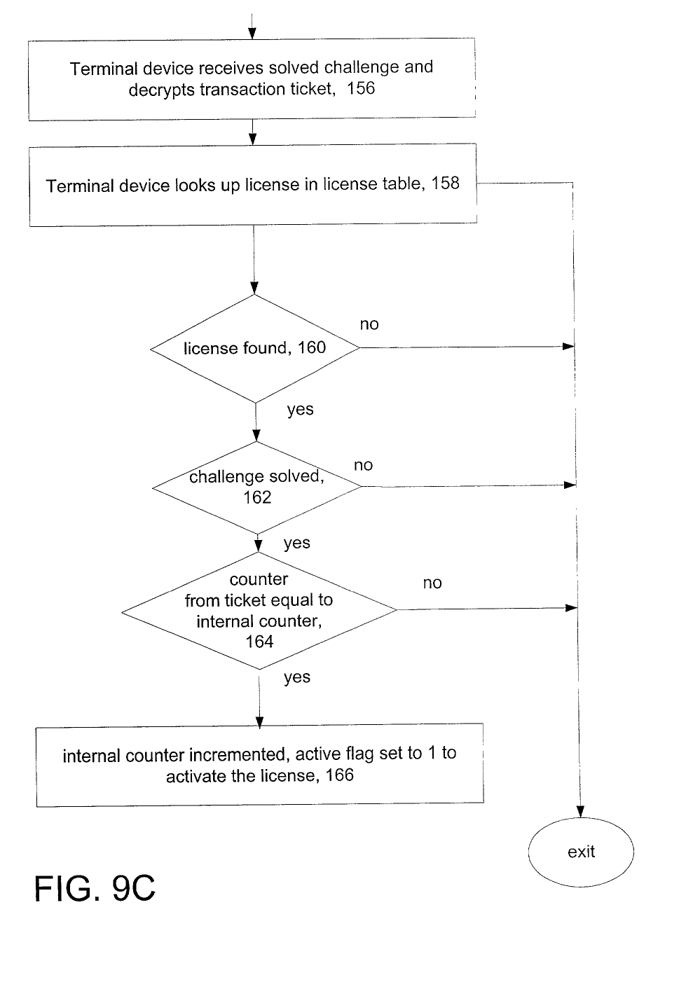

Referring to FIGS. 9A-9C, details 130 of the process 120 (FIG. 8) for initial registration of a new license by the terminal device 12 includes producing 132 a new entry in protected table of e-content licenses. Producing a new entry causes the ticket 90 counters to be set to zero. The license key is decrypted 134 using the device's private key, but the license is not yet activated. The terminal device 12 produces 136 a new transfer ticket 90a. The transfer ticket 90a includes the dedicated device id, the e-content's license id and a unique serial number (for new licenses, this number is always zero). The internal counter is incremented when the request is completed. The terminal device 12 encrypts 138 the transfer ticket 90a with private key and generates an arbitrary, random number (i.e., challenge 91). The terminal device 12 stores 140 the random number in its license table, until registration is completed. The terminal device 12 encrypts 142 the random number with the public key, and sends a packet to content server 18, comprising the unique request ID, unique device ID, encrypted transfer ticket 90a and encrypted challenge.

The content server 18 uses 144 the service of the key server 16 to decrypt the transfer ticket 90a. The content server 18 checks 146 if there is an entry for the e-content license/dedicated device id pair in the license repository. If there is no entry then the content has not been downloaded. The content server 18 checks 148 if the license has an owner assigned. If yes, activation is denied, because the license already has been activated (unless there is a corresponding relinquishing ticket, discussed below). The content server 18 checks 149 if the transfer ticket 90a counter matches the value in the license repository. If not, the transfer ticket 90a has already been used to activate this license. If all above checks passed, the content server 18 assigns 150 the device as owner in license repository and uses the key server 16 for solving the challenge 152.

The content server 18 sends the response back to the terminal device 12. The response includes the original transfer ticket 90a, having the license ID, the device ID, the serial counter, and the decrypted random number (solved challenge).

Typically, billing information (such as credit card number) is sent along with the request, the customer is billed when the license is activated. The package returned to the terminal device 12 must not get lost, since it is created only once. In other words if the transfer ticket 90a is used one more time, the check would fail, because the value of the transfer ticket 90a counter is expected to be one (1). In order to make sure that the challenge reaches the user, the response should be sent in more than one channel, and a backup copy should be kept on the content server 18.

Upon receiving the transfer ticket 90a and solved challenge, the terminal device 12 decrypts 156 the transfer ticket 90a by using the public key. The decryption of the transfer ticket 90a yields the dedicated device id, e-content id, and serial counter. The terminal device 12 looks-up 158 the license in the license table. If the license cannot be found, activation fails. The terminal device 12 checks 160 if the challenge has been solved by comparing the solved challenge to the original value stored in license table. If not equal activation fails (most likely because the response did not come from a valid server). The terminal device 12 also compares 162 the serial counter from the transfer ticket 90a to the internal counter of the license. If not equal, activation fails (because the transfer ticket 90a has already been used). If equal, internal counter is incremented 164 and the active flag is set in one single instruction (atomic operation) to activate the license. Incrementing the internal counter makes sure that the transfer ticket 90a cannot be used any more to activate the same license again.

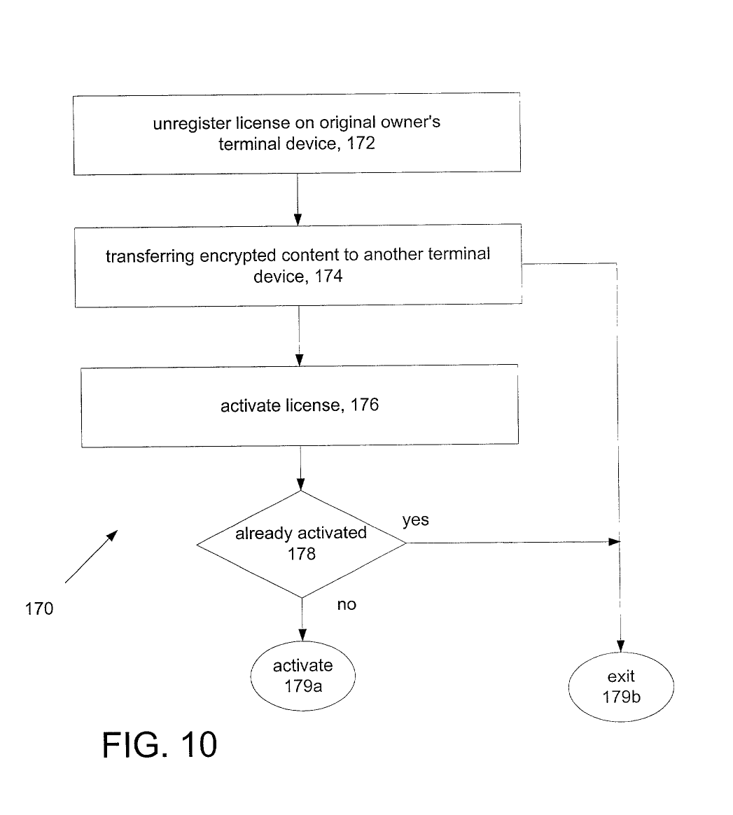

Referring to FIG. 10, peer to peer operation allows unregistering licenses from one device and registering the license on another terminal device 12, so that it can be viewed or otherwise used on another terminal device 12. A process 170 for trading content involves unregistering 172 the license on one terminal device 12 and transferring 174 the encrypted content to the other terminal device 12, i.e., a borrower's terminal device 12. This can be done over insecure channels (eMail, CD, . . . ). The e-content can be activated 176 on the borrower's terminal device 12 or alternatively the license can be reregistered on the original device. The system 10 ensures that only one license gets activated however. The system 10 follows the first come first serve principle. Thus, the content server 18 will check 178 if it has already been registered. If not it will cause the process to activate the license to be executed 179a when either the original owner or borrower comes to register it. The last one of the two that tries to register will be denied 179b.

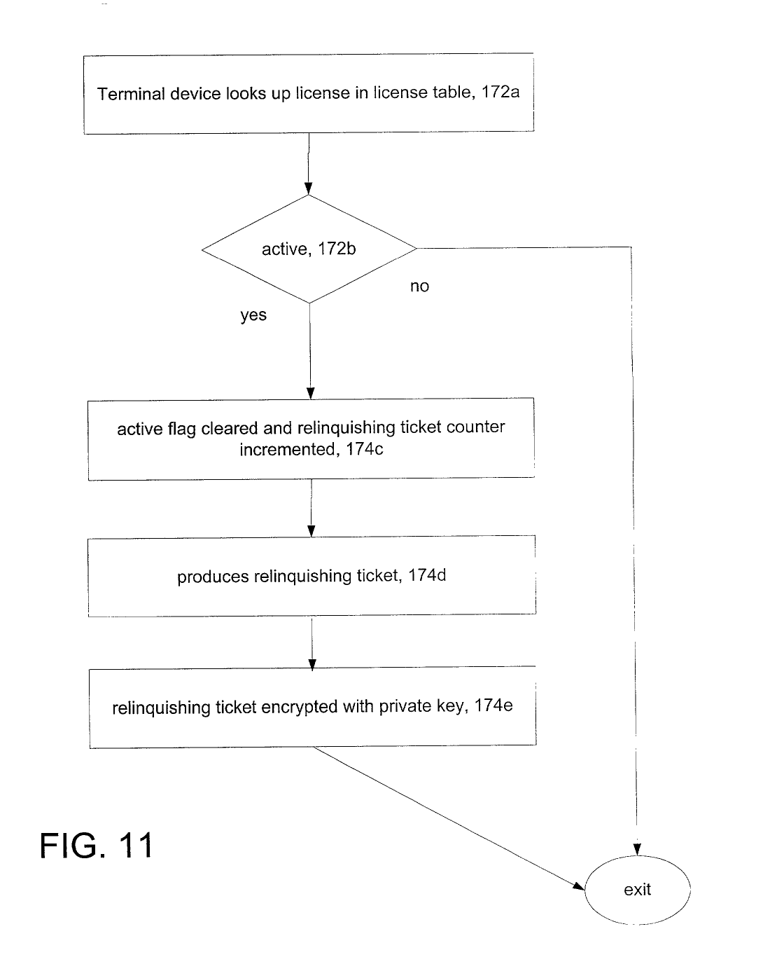

Referring to FIG. 11 during a process 172 to unregister a license the content license is deactivated on the terminal device 12 and a proof certificate is issued. Unregistering does not require an online connection to content server 18 or key server 16. For uiregistering licenses, the terminal device 12 looks up 172a the license in the license table. If active 172b, the active flag is cleared 172c and the value of the relinquishing ticket 90b counter is increased by one in one single instruction (atomic operation). The terminal device 12 produces 172d a relinquishing ticket 90b. This relinquishing ticket 90b has the unique dedicated device id, the unique license_id, and the current value of the relinquishing ticket 90b counter. The relinquishing ticket 90b is the aforementioned proof certificate. The relinquishing ticket 90b is encrypted 172e with the private key. The relinquishing ticket 90b therefore cannot be faked by a user. The license is not removed from the license table, rather the license is only deactivated by clearing the active bit.

Subsequent attempts to unregister the license will check if the license is there and if the active bit is cleared. If yes, they will issue the relinquishing ticket 90b without incrementing the counter first. At this point, either the borrower activates the copy of the license using the relinquishing ticket 90b, or the original owner reactivates the copy. Whoever does this first is granted access to the e-content, as discussed above.

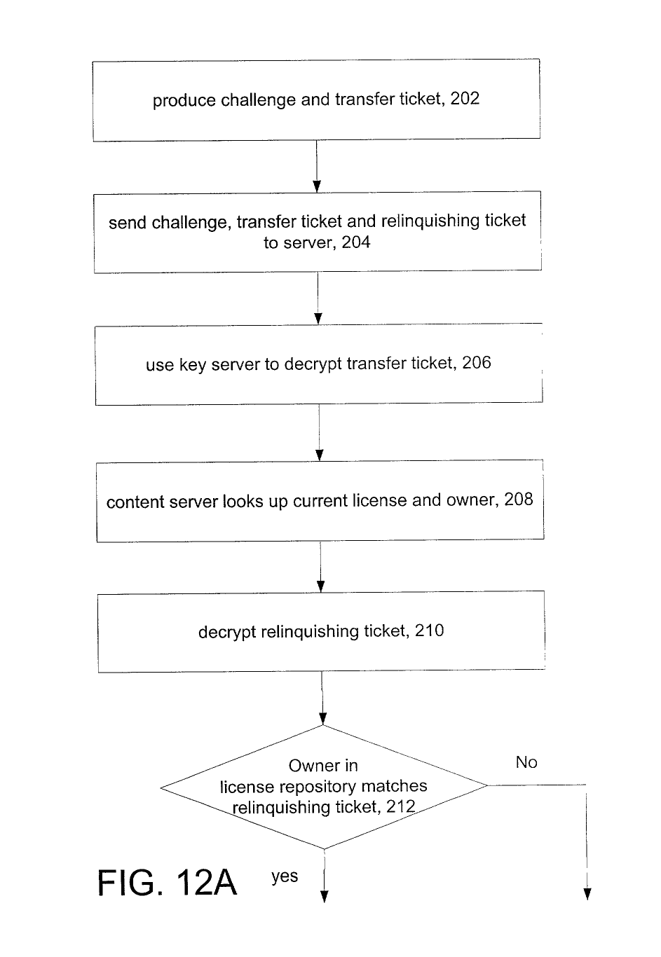

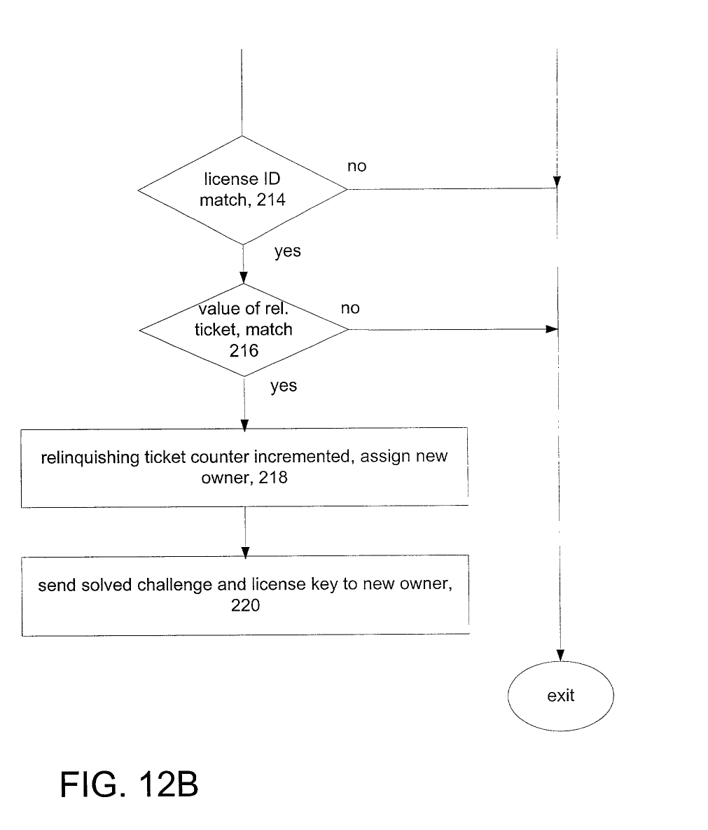

Referring to FIG. 12A and 12B, a process 200 for registering a license for another device is shown. The procedure is similar to the activation procedure described above. However, now there are two terminal devices 12, the original and borrower devices and a relinquishing ticket 90b. The original or the borrower terminal device 12 produces 202 a challenge and a transfer ticket 90a, as described above, and sends 204 the challenge and transfer ticket 90a to the content server 18. The original or the borrower terminal device 12 also sends the proof certificate, i.e., relinquishing ticket 90b in the request.

The content server 18 uses 206 the key server 16 to decode the transfer ticket 90a. The content server 18 looks up the content license by using the License_ID from the transfer ticket 90a. The content server 18 looks up 208 current owner of license and uses 210 the public key from the owner's dedicated device entry to decrypt the relinquishing ticket 90b. If the owner is not 212 the one who issued the relinquishing ticket 90b, then the result is a meaningless sequence of bytes. Thus, all subsequent checks will fail. This happens if the user gave the relinquishing ticket 90b (and the whole e-content) to more than one user (a case which is covered by system 10) and somebody else already activated the content. The content server 18 checks 214 if the license id of the relinquishing ticket 90b matches the request. If not, the transaction fails. The content server 18 looks up the corresponding entry of the current owner in the license table and checks 216 if the value of the relinquishing ticket 90b matches the counter of the current owner's license history. If the values do not match, the transaction fails. This happens if the owner reactivated the content first.

If all checks succeed, the value of the relinquishing ticket 90b counter for the current owner is incremented 218 in the owner database. Any subsequent use of the same relinquishing ticket 90b thus will fail. The e-content license is assigned the other terminal device 12 (borrower device) as the new owner. The server solves the challenge and sends 220 the solved challenge and transfer ticket 90a back to the new terminal device 12 as described above. It also sends the license key encrypted with the new device's private key. The system 10 gives preference to the registration that occurs first to ensure that only one license is granted.

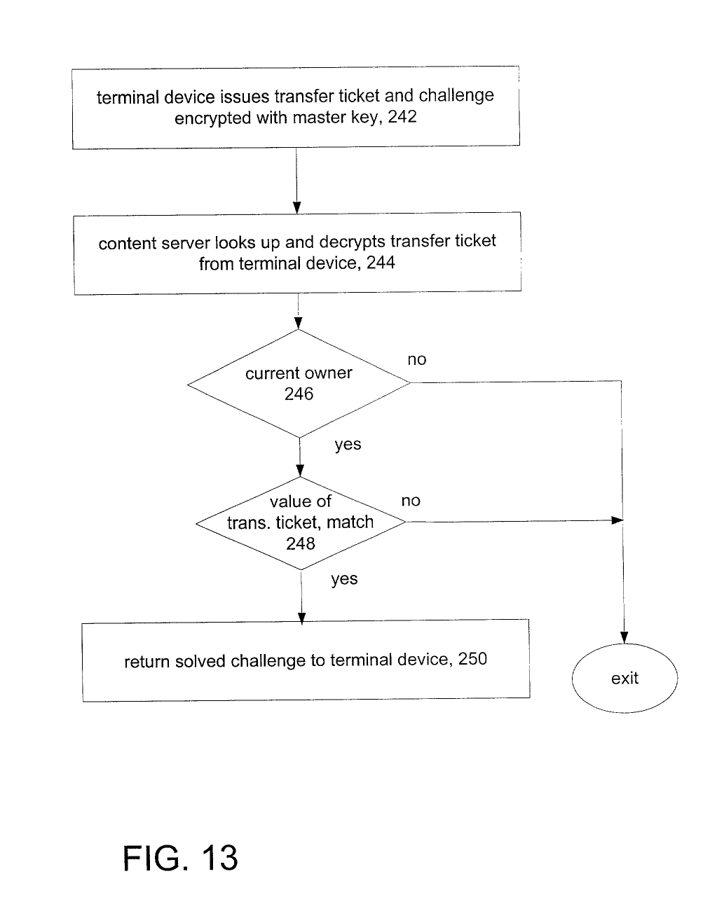

Referring to FIG. 13 a process to reregister 240 the license on the same device is shown. This process is used when the user of the original terminal device 12 reconsiders and decides to reregister content. The relinquishing ticket 90b is not needed for that purpose, since the content server 18 knows that the terminal device 12 is the owner of the license. The original terminal device 12 proves 242 that the content has been deactivated to the server by issuing a transfer ticket 90a (with a non-zero value). The terminal device 12 issues the transfer ticket 90a only if e-content is deactivated. The content server 18 knows that the giver is the current owner of the e-content license. The terminal device 12 produces a challenge for the server to solve and sends the challenge and the transfer ticket 90a with a non-zero value encoded with the device's private key to the server. The content server 18 looks up and retrieves 244 the public key for decrypting the transfer ticket 90a. The content server 18 looks up the e-content license by the e-content license id from the transfer ticket 90a. The content server 18 checks if the current owner of the license is the terminal device 12. If not, the license had already been registered by another device and the request fails. Otherwise, the content server 18 checks if the transfer ticket's 90a counter value matches the current value in the license history. If not, then either an old ticket 90 was used or a ticket 90 was faked. Otherwise, if all checks pass, content server 18 returns 250 the solved challenge and transfer ticket 90a back to dedicated device, and the license is re-registered.

Set forth is examples of transactions that can occur involving the license. Assume that there are four users user_A, user_B, user_C, and user_D and one e-content license license_1. The users can trade the license_1. In some transactions the trade is valid and in others the trade is invalid.

Initially, user_A buys e-content license 1. User-A trades license_1 to user_B. User_B trades license to user_C, by deactivating the license or relinquishes the license by giving user_C a relinquishing ticket. However, before user_C can activate the license, user_B reconsiders and reactivates license_1. When user_C tries to activate license_1 the activation fails because User_B reconsidered and reactivated the license before User_C could activate it.

Assume that user_B reconsiders again, and trades e-content license I to user_C and user_D. User_B trades the license_1 by giving the relinquishing ticket 90b to both of them. This time, user_D activates the content before user_B and user_C do. User_B tries to reactivate license_1 and fails, and User_C also tries to activate license_1 and fails. As last step user D returns the e-content license_1 to user_A by giving a relinquishing ticket.

From the above example, it is clear that attempts by intruders to transfer the license through an invalid transfer fail. For example, applying a transfer ticket 90a twice or attempting to issue a transfer ticket 90a one more time will cause the system 10 to reject license transfers. Similarly, when user_C tries to activate the license he got from user_B, after user_B reactivated it that transfer will also be rejected. Similarly if user_C tries to activate the license from user_B, after user_D activates the license_1 user_C's attempt to activate the license will likewise fail so to would user_B trying to reactivate his license, after user_D activated it.

The security of the e-content depends maintaining the secrecy of the private key. That is, there is no way to break system 10 without knowledge of the private key because all defined actions (like decrypting of content, check applications certificate, registering licenses) require knowledge of the private key. Use of a content decryption interface is only allowed for authorized and authentic software modules. Therefore, it is not possible to intercept content in the terminal device or elsewhere in the system 10. The system 10 is resistant to these types of known attacks. Attacks at a physical level, Trojan horse attacks, attacks at operating system 10 level, reading memory that holds unencrypted content and debugging, and intercepting running programs that deal with content. In addition, reverse engineering of software does not produce a security problem, because it is not possible to intercept the private key in the system 10 and use the information gathered in a reverse engineering process. The process is also resistant to attacks against the ciphers. That is, in an attempt to decrypt the data without knowing the key, or trying to figure out keys from samples would not work. It is also resistant to man-in-the-middle attacks, which can be shown by formal verification techniques. Also, it is resistant to software architecture implied attacks, such as faking tickets or activating licenses more than once. In particular, such attempts like retaining a copy of the E-content when giving e-content away would be futile. Also, domain spoofing of the key server 16 domain (i.e., intruders attempting to replace key server 16 by some other server) are defeated by giving out challenges.

The system 10 features secure content distribution, storage and viewing. It can support any file format or media type (audio, video, etc.). The system 10 allows distribution over insecure channels (such as internet or shipping). The system also allows software on terminal devices to be upgraded in any way at a later point in time, thus preserving investment. The system also allows users to make backup copies of the encrypted content. The system 10 also allows moving content license from one terminal device 12 to another, so that users can view content on their preferred device.

A number of embodiments of the invention have been described. Nevertheless, it will be understood that various modifications may be made without departing from the scope of the invention. Accordingly, other embodiments are within the scope of the following claims.

What is claimed is:

1. A method of downloading encrypted e-content to a terminal device comprises:
receiving a request for encrypted content from a terminal device;
generating a symmetric key and encrypting the e-content with the symmetric key;
sending a request to a key server to look up the terminal device public key in a key repository;
receiving from the key server the symmetric key encrypted with the public key of the terminal device;
generating a unique license ID and producing a new entry in a license repository; and
sending a response to the terminal device including the content encrypted with the symmetric key.

2. The method of claim 1 further comprising:
activating the license to allow the terminal device to allow consumption of the e-content at the terminal device.

3. The method of claim 1 wherein the request received by the content server comprises:
a unique request ID, unique content ID and unique device ID.

4. The method of claim 1 wherein sending the request to the key server comprises:
sending a request that includes a unique request ID2, a unique ID of device, and the symmetric key over a secure channel.

5. The method of claim 1 wherein receiving from the key server further includes the unique request ID2, the unique ID of device and the symmetric key encrypted with public key.

6. The method of claim 1 wherein the public key is used for encrypting the symmetric key.

7. The method of claim 1 wherein generating a unique license ID further comprises:
generating a unique license ID and producing a new entry in the license repository and storing the license ID and symmetric key in the license repository.

8. The method of claim 1 further comprising:
receiving a request to register the license with the content server upon receipt of the response to the terminal device from the content server.

9. The method of claim 1 assigning an owner after the license is registered.

10. The method of claim 1 further comprising:
sending from the content server to the key server a free form data to be encrypted with the terminal device's private key to control further properties of content usage; and
receiving by the content server from the key server the encrypted data structure.

11. The method of claim 10 wherein the data structure controls usage characteristics such as expiration date and maximal view count.

12. A method of activating e-content license with terminal device comprises:
sending to a content server a transfer ticket and challenge;
receiving a solved challenge and transfer ticket back from the content server; and
checking the challenge and transfer ticket to activate the e-content license.

13. The method of claim 12 further comprises:
storing the activated e-content license in a protected memory area of the terminal device.

14. The method of claim 12 further comprises:
producing the transfer ticket and the challenge by the terminal device.

15. The method of claim 12 wherein the e-content can be read after completion of activating the license.

16. The method of claim 12 wherein the transfer ticket is used to ensure that registering of e-content licenses happens only once.

17. The method of claim 12 wherein the solved random challenge received from the content server ensures that the terminal device actually communicated with the content server.

18. The method of claim 12 further comprising:
checking, upon receipt of the transfer ticket and the challenge by content server, if the counter value of the transfer ticket matches the expected value of the counter; and
incrementing the expected value after checking the counter value.

19. The method of claim 12 wherein the transfer ticket further comprises:
a unique counter value, a license id, and device id and wherein the transfer ticket is encrypted with a private key of the terminal device

20. The method of claim 12 wherein the challenge is a random number encrypted with the public key of the terminal device.

21. The method of claim 13 wherein activating the license comprises:
setting a flag in the license table in an atomic operation that also increments an internal that tracks the value of the transfer ticket so that it cannot be used again to activate the same license.

22. A method of trading e-content licenses between users, comprises:
unregistering e-content license at a giver's device;
issuing a relinquishing ticket by the giver's device; and
registering the license with a borrower's device using the issued relinquishing ticket.

23. The method of claim 22 wherein issuing a relinquishing ticket by giver's device further comprises:
producing the relinquishing ticket by the giver's device having a counter value, license id and device id; and
encrypting the relinquishing ticket with the private key of the giver's device.

24. The method of claim 23 further comprising:
incrementing the internal relinquishing ticket counter when the license is unregistered.

25. The method of claim 23 further comprising:
producing a copy of the e-content for a giver to transfer to a borrower.

26. The method of claim 23 further comprises:
sending a copy of the relinquishing ticket from the giver device to the borrower device.

27. The method of claim 23 further comprises:
sending the relinquishing ticket to the content server by the giver or the borrower.

28. The method of claim 22 wherein registering comprises:
producing a transfer ticket and challenge and sending the transfer ticket and challenge to the content server.

29. The method of claim 28 wherein upon activation of the license the method further comprises:
receiving from the server a solved challenge, transfer ticket and a license key encrypted with the new device's private key.

30. A method executed on a content server for allowing activation of an e-content license transferred from a giver's terminal device to a borrower's terminal device comprises:
receiving a relinquishing ticket and challenge from the giver's terminal device;
checking a value of the relinquishing ticket;
incrementing the expected value of relinquishing ticket for the giver's device.
assigning borrower device as new owner;
sending a solved challenge and a transfer ticket back to the borrower's terminal device to allow the borrower terminal device to check the challenge and the transfer ticket to activate the e-content license.

31. The method of claim 30 wherein the content server checking the relinquishing ticket further comprises:
decrypting the relinquishing ticket with the public key of the giver's device.

32. The method of claim 30 further comprising:
checking if the relinquishing ticket counter value matches the expected value of the relinquishing ticket and incrementing the expected value thereafter.

33. The method of claim 30 wherein checking the transfer ticket further comprises:
decrypting relinquishing ticket with public key of borrower.

34. The method of claim 30 further comprising:
checking if the transfer ticket's counter matches the expected value of the transfer ticket, and incrementing the expected value thereafter.

35. A method executed on a terminal device for reregistering an e-content licenses after unregistering the e-content, comprises:
sending by a transfer ticket and a challenge to a content server;
receiving from the server to the terminal device a solved challenge and checked transfer ticket; and
checking by the terminal device that the challenge is correct and transfer ticket is correct to activate the e-content license on the terminal device.

36. A method of viewing secure content on a personal computer that executes a non secure operation system, comprises:
providing a secure extensible computing environment on a personal computer peripheral card; and
processing the content in an encrypted form in the computer and delivering the content in encrypted form to the secure extensible computing environment on the personal computer peripheral card; and
decrypting the content in encrypted form on the personal computer peripheral card.
